(19) United States
(12) Patent Application Publication
(10) Pub. No.: US 2010/0158382 A1
(43) Pub. Date: Jun. 24, 2010

(54) SYSTEM AND METHOD FOR DETECTING FACE

(75) Inventors: Jae II CHO, Daeleon (KR); Seung Min Chol, Daeleon (KR); Ji Ho Chang, Daeleon (KR); Dae Hwan Hwang, Daeleon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/552,624

(22) Filed: Sep. 2, 2009

(30) Foreign Application Priority Data
Dec. 18, 2008 (KR) 10-2008-0129632

(51) Int. Cl. G06K 9/46

(52) U.S. Cl. 382/190

(57) ABSTRACT

The system for detecting a face pattern from an input image includes a window extraction unit, a cost calculation unit, and a face pattern discrimination unit. The window extraction unit receives a pre-processed image corresponding to the input image to scan the preprocessed image in a certain window size, and parallelly outputs pre-processing coefficient values corresponding to the scanned pre-processed image. The cost calculation unit parallelly receives the pre-processing coefficient values corresponding to the window size, calculates cost values corresponding to the pre-processed coefficient values, and sums the cost values. The face pattern discrimination unit compares the sum of the cost values with a preset threshold value and discriminates if the pre-processed image corresponding to the window size is the face pattern.

### CROSS-REFERENCE TO RELATED APPLICATIONS

This application claims priority under 35 U.S.C. §119 to Korean Patent Application No. 10-2008-0129632, filed on Dec. 18, 2008, in the Korean Intellectual Property Office, the disclosure of which is incorporated herein by reference in its entirety.

### TECHNICAL FIELD

The present disclosure relates to a system and a method for detecting a face, and in particular, to a system and a method for detecting a face based on an image, using Human Robot Interaction (HRI) technology for intelligent robots.

### BACKGROUND

Generally, face recognition technology is widely used in the technical fields of user authentication, security systems, and Human Robot Interaction (HRI). Face recognition technology is implemented in a non-contact manner, unlike ID card technology and fingerprint recognition technology. Accordingly, face recognition technology is widely used because users do not express reluctance or complain of inconvenience (as opposed to a contact manner) and because no additional sensor equipment is needed.

Face recognition technology requires face detection technology for pre-processing. Face detection technology is generally implemented through a process of classifying an image of a face into face patterns and non-face patterns.

Examples of related art face detection technologies include the Skin Color based approach, the Support Vector Machine (SVM) approach, the Gaussian Mixture approach, the Maximum Likelihood approach, and the Neural Network approach.

The basic requirements for embodying the above technologies in hardware are establishing a database for storing information on face patterns and non-face patterns, and establishing a look-up table for storing cost values of facial features. A cost value is a predictive value that expresses the possibility of a face existing as a numerical value, based on internally-collected statistical data. With these technologies, relatively high-quality facial detection performance may be ensured when the look-up table and the database contain great amounts of data.

However, this related art face detection technology is unable to provide real-time face detection performance due to the time required to access the look-up table, scaling of the look-up table, and excessive operations such as add operations that are performed.

### SUMMARY

In one general aspect, a system for detecting a face pattern from an input image includes: a window extraction unit receiving a pre-processed image corresponding to the input image to scan the preprocessed image by a certain window size, and parallelly outputting pre-processing coefficient values corresponding to the scanned pre-processed image; a cost calculation unit parallelly receiving the pre-processing coefficient values corresponding to the window size, calculating cost values corresponding to the pre-processed coefficient values, and summing the cost values; and a face pattern discrimination unit comparing the sum of the cost values with a preset threshold value and discriminating if the pre-processed image corresponding to the window size is the face pattern.

In another general aspect, a system for detecting a face pattern from an input image includes: an image transformation unit transforming the input image including a unit pixel of n (where, n is a natural number) bit into a pre-processed image of m (where, m is a natural number greater than n) bit; a window extraction unit including a memory scanning the pre-processed image by a certain window size, storing coefficient values of the pre-processed image corresponding to the window size by horizontal line unit, and parallelly and simultaneously outputting the coefficient values stored by horizontal line unit; a cost calculation unit parallelly receiving the pre-processing coefficient values corresponding to the window size, calculating cost values corresponding to the pre-processed coefficient values, and summing the cost values; and a face pattern discrimination unit comparing the sum of the cost values with a preset threshold value and discriminating if the pre-processed image corresponding to the window size is the face pattern.

In another general aspect, a method for detecting a face pattern from an input image includes: parallelly calculating pre-processing coefficient values corresponding to a pre-processed image by receiving a pre-processed image corresponding to the input image and scanning the pre-processed image by a certain window size; summing cost values by parallelly receiving the calculated pre-processing coefficient values and calculating the cost values corresponding to the pre-processed coefficient values; and discriminating if the input image corresponding to the window size is the pace pattern, by comparing the sum of the cost values with a preset threshold value.

In another general aspect, a method for detecting a face pattern from an input image includes: transforming the input image including a unit pixel of n (where, n is a natural number) bit into the pre-processed image including a unit pixel of m (where, m is a natural number greater than n) bit; parallelly calculating pre-processing coefficient values corresponding to a pre-processed image by receiving a pre-processed image corresponding to the input image and scanning the pre-processed image by a certain window size; summing cost values by parallelly receiving the calculated pre-processing coefficient values and calculating the cost values corresponding to the pre-processed coefficient values; and discriminating if the input image corresponding to the window size is the pace pattern, by comparing the sum of the cost values with a preset threshold value.

Other features and aspects will be apparent from the following detailed description, the drawings, and the claims.

### BRIEF DESCRIPTION OF THE DRAWINGS

FIG. 1 is a flowchart illustrating a face detection method using an Adaboost scheme according to an exemplary embodiment.

FIG. 2 is a diagram illustrating an Adaboost scheme applied to an exemplary embodiment, showing an exemplary process for calculating the cost value.

FIG. 3 is a block diagram illustrating a face detection system according to an exemplary embodiment.

FIG. 4 is a circuit diagram illustrating an exemplary internal configuration of the window extraction unit in FIG. 3.

FIG. 5 is a diagram illustrating an exemplary internal configuration of a cost calculation unit in FIG. 3.

FIG. 6 is a diagram illustrating a look-up table in FIG. 5.

FIG. 7 is a diagram illustrating an exemplary internal process of a cost calculation unit in FIG. 3.

### DETAILED DESCRIPTION OF EMBODIMENTS

Hereinafter, exemplary embodiments of a system and a method for detecting a face will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/of systems described herein will be suggested to those of ordinary skill in the art. Also, descriptions of well-known functions and constructions may be omitted for increased clarity and conciseness.

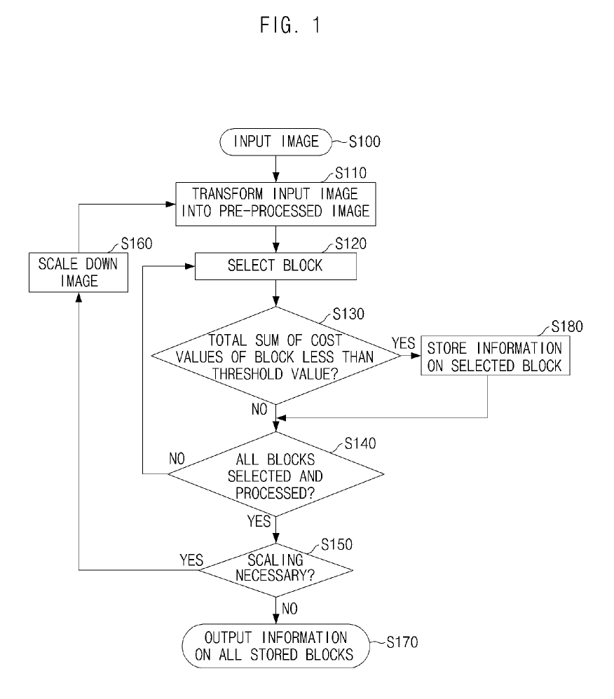

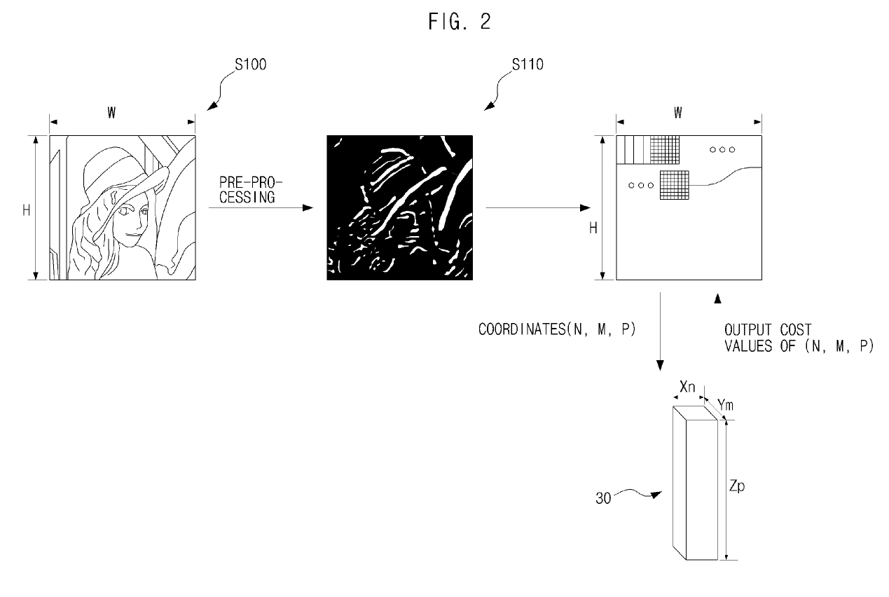

A system and a method for detecting a face according to an embodiment uses an Adaboost scheme to quickly detect a face in real-time. General description of an Adaboost scheme will be described with reference to FIGS. 1 and 2.

FIG. 1 is a flowchart illustrating a face detection method using an Adaboost scheme according to an exemplary embodiment.

In order to explain FIG. 1, an Adaboost scheme applied to an exemplary embodiment will be described using a specific numerical value. The resolution of the input image is assumed to be 320×240. The gradation value per pixel is represented by 8-bit data. The size of a block selected from a pre-processed image is assumed to be 20×20.

Referring to FIG. 1, in operation S100, the input image (or the input image frame) having an 8-bit gradation value corresponding to 320 (number of row pixels)×240 (number of column pixels) size is inputted from a certain photographing device (e.g., a camera).

In operation S110, the input image is transformed into a certain image through a transformation such to Modified Census Transformation MCT used in advance for making a look-up table of 20×20 image size in order to extract features of a face. A pre-processed image including a pre-processing coefficient is generated during this image transformation process. That is, a gradation value of each pixel of the input image is converted into a pre-processing coefficient value.

In operation S120, the pre-processed image is divided into blocks having an image size of 20×20 from the left top of the pre-processed image. Then, cost values are calculated from the pre-processing coefficients of the divided 20×20 block. Calculation of the cost values corresponding to 20×20 pre-processing coefficients is performed with reference to the 20×20 look-up table (30 in FIG. 2) including the cost values corresponding to the pre-processing coefficients.

In operation S130, the total sum of all cost values in the calculated block is calculated. Then, the total sum of the cost values is compared with a preset threshold value. In operation S180, if the total sum of the cost values is less than the threshold value, the block corresponding to the total sum of the cost values is discriminated as a face pattern, and all information on the block discriminated as the face pattern is stored in a storage medium.

In operation S140, While moving from the left top to the right bottom of the pre-processed image by one pixel, the above operations S120 and S130 are repeatedly performed until the divided 20×20 image block reaches the right bottom of the pre-processed image.

In operation S150, in order to detect a face positioned at a different distance from a photographing device—for example, a face having an image size of more than 20×20—the input image acquired from the photographing device is scaled. In operation S160, for example, the input image is scaled down. The operations S120, S130, S140 and S180 are again performed with respect to the scale-downed input image. In operation S170, the block information on all blocks is outputted from the storage medium.

Hereinafter, an Adaboost scheme applied to an embodiment will be described in detail with reference to FIG. 2.

FIG. 2 is a diagram illustrating an Adaboost scheme applied to an exemplary embodiment, showing an exemplary process for calculating the cost value.

In order to explain FIG. 2, an Adaboost scheme applied to an exemplary embodiment will be described using a specific numerical value. First, it is assumed that the resolution of the input image is 320×240. Accordingly, W is 320, and H is 240. In this case, the gradation value per pixel is expressed by 8-bit data. The size of the block selected from the pre-processed image is assumed to be 20×20. In this case, the size of the look-up table 30 and the size of the block selected from the pre-processed image are similar to each other. Accordingly, the row length of the look-up table 30 is 20, and the column length thereof is 20. Here, the depth of the look-up table 30 is assumed to be P and the P is assumed to be 2⁹, i.e., 512. The depth of the look-up table 30 is defined as the number of binary trees of data bits in a unit pixel of the pre-processed image. Accordingly, the number of data bits in the unit pixel of the pre-processed image is nine.

Xn described in FIG. 2 is the abscissa of a block, and simultaneously the abscissa of the look-up table. Ym is the ordinate of the block, and simultaneously the ordinate of the look-up table. Zp is a coefficient value of the pre-processed image corresponding to the coordinate (Xn, Ym), and simultaneously the depth coordinate of the look-up table.

In operation S100, an input image having a pixel resolution of Quarter Video Graphics Array (QVGA)-class (320×240) is inputted. Then, the input image is transformed into a pre-processed image through a transformation process. In this transformation process, the gradation value of 8-bit corresponding to one pixel is converted into a pre-processing 9-bit coefficient value.

There are 66,000 (=(320−10−10) (240−10−10)) pre-processing coefficient values (hereinafter, referred to as coefficient values) from the left top to the right bottom of the pre-processed image. In operation S120, blocks of 20×20 size are selected based on each coefficient value. Accordingly, 400 coefficient values of 9-bits exist in each block.

A position coordinate of coefficient value (Xn, Ym) in one block, and a coefficient value of 9 bits stored in the position coordinate (Xn, Ym) are used as an address for access to the look-up table 30.

Then, one cost value corresponding to the address is outputted from the look-up table 30. The remaining 399 cost values existing in one block are outputted. In operation S130, 400 cost values are summed, and the total sum of the cost values is compared with a preset threshold value.

For example, when the sum of the cost values is less than the preset threshold value, the corresponding block is discriminated as a face pattern. In operation S180, information on the corresponding block discriminated as the face pattern is stored in a storage medium.

In operation S140, operations S120 and S130 are repeatedly performed 66,000 times while moving by pixel unit on the pre-processed image. The sizes of row and column of the input image are scaled down by k %, respectively. The operations S110 through S140 are repeatedly performed. The k is appropriately determined in consideration of a trade-off between the face detection success rate and the operation speed.

In operation S170, if the size of the block becomes smaller than 20×20 through image scaling, the scaling process is discontinued, and coordinate values of the block stored during operation S180 are outputted.

Thus, the face detection technology using the Adaboost scheme, if the look-up table is elaborately designed, shows high face detection performance of more than 90%. As described above, however, the above operations S120 to S140 including a memory access and add operation are repeatedly performed because scale-down operation S160 of the image is performed many times. If an image of 30 frames per second is inputted, the number of commands to be operated per second may exceed several Gigas.

By minimizing the load of operation processing and efficiently using the look-up table, a face detection system capable of quickly detecting a face in real-time based on an Adaboost scheme will be described below.

An Adaboost-based face detection system according to an embodiment, as described above, detects a face by scanning an input image by 20×20 window size with reference to a look-up table (20×20 sized image equals 400 points) corresponding to face feature points (cost values).

In order to detect a face positioned at a different distance from a photographing device (e.g., a camera)—for example, a face having an image size of more than 20×20—the face detection system scales down the input image at a scaling ratio of about 88% after the scanning of the input image, and re-scans the scaled-down input image by a window size of 20×20.

The scale down of the input image is repeated until the size of the input image equals the size (e.g., 20×20) of the look-up table.

TABLE 1

| | Image | | Test Effective | | Number of Test |
|---|---|---|---|---|---|
| Scale Down | Resolution | | Resolution | | Images (Cost |
| Ratio (88%) | Width | Height | Width | Height | Value Calculation) |
| 1 | 320 | 240 | 300 | 220 | 66000 |
| 2 | 280 | 210 | 260 | 190 | 49400 |
| 3 | 245 | 184 | 225 | 164 | 36844 |
| 4 | 214 | 161 | 194 | 141 | 27364 |
| 5 | 188 | 141 | 168 | 121 | 20224 |
| 6 | 164 | 123 | 144 | 103 | 14860 |
| 7 | 144 | 108 | 124 | 88 | 10842 |
| 8 | 126 | 94 | 106 | 74 | 7845 |
| 9 | 110 | 82 | 90 | 62 | 5619 |
| 10 | 96 | 72 | 76 | 52 | 3975 |
| 11 | 84 | 63 | 64 | 43 | 2769 |
| 12 | 74 | 55 | 54 | 35 | 1891 |
| 13 | 64 | 48 | 44 | 28 | 1260 |
| 14 | 56 | 42 | 36 | 22 | 812 |
| Total | | | | | 249705 |

Table 1 shows the frequency of scale-downs and the number of the test images necessary for a corresponding image processing in the case of an input image having a resolution of 320×240.

When the first input image of 320×240 is scanned by a window size of 20×20, the input image scanned by the window size of 20×20 has effective coordinate points of 300×200, excluding 10 from all sides, respectively. Accordingly, when the first input image of 320×240 is scanned by the window size of 20×20, the number of test images is 66,000.

The first input image of the 320×240 is scaled down to the second input image of about 280 (≈320×0.88)×about 210 (≈240×0.88) at a scale down ratio of about 88%. When the second input image is scanned by the window size of 20×20, the scanned input image has effective coordinate points of 260×190, excluding 10 from all sides, respectively. In this case, the number of test images is 49,400.

Thus, the 14th input image has the coordinate points of 36×22. The number of test images is 812.

As a result, the total number of test images for one frame of the input image of 320×240 is 249,705.

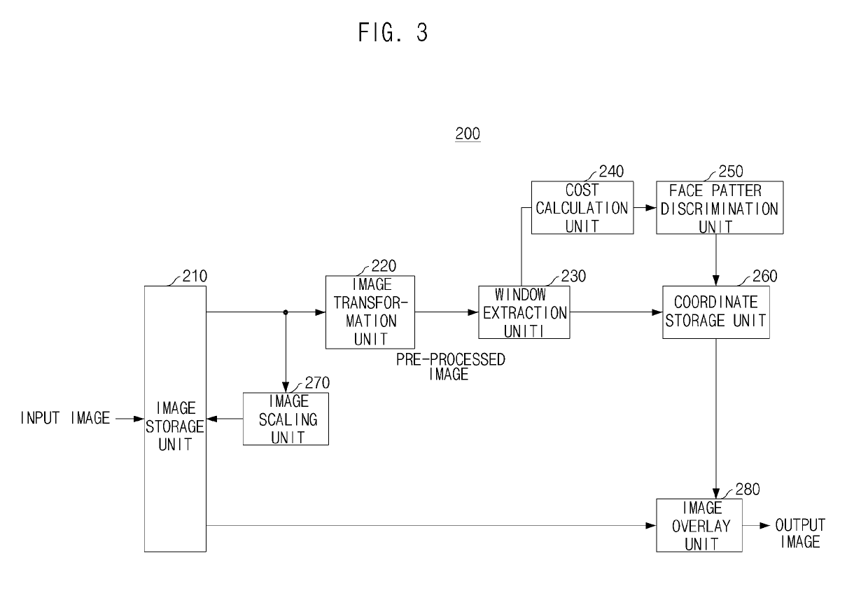

FIG. 3 is a block diagram illustrating a face detection system according to an exemplary embodiment.

Referring to FIG. 3, a face detection system 200 includes an image storage unit 210, an image transformation unit 220, a window extraction unit 230, a cost calculation unit 240, a face pattern discrimination unit 250, a coordinate storage unit 260, an image scaling unit 270, and an image overlay unit 280.

The image storage unit 210 receives an input image of 30 frames per second, and sequentially stores the received input image by frame unit. The input image sequentially stored in the image storage unit 210 is sequentially outputted by frame unit. It is assumed that the input image includes pixels of 320×240, and each pixel includes image data of 8-bits. Each pixel has a gradation value from 0 to 255.

The image transformation unit 220 receives the input image from the image storage unit 210 sequentially, and transforms the input image into a pre-processed image highly tolerant of changes in illumination and the like. If the image transformation unit 210 transforms an image through an image transformation scheme—for example, a Modified Census Transform (MCT)—the 8-bit image data is transformed into a pre-processing coefficient value (hereinafter, referred to as an MCT coefficient value) of 9-bits that has increased by 1-bit. Accordingly, each pixel of the pre-processed image has an MCT coefficient value from 0 to 511.

The input image outputted from the image storage unit 210 is inputted into the image transformation unit 220, and simultaneously into the image scaling unit 270. The image scaling unit 270 scales the input image. The image scaling unit 270 scales down the input image at a scale-down ratio of about 88%, and stores the scaled-down input image in the image storage unit 210 again.

The window extraction unit 230 sequentially scans the pre-processed image outputted from the image transformation unit 220 by a window size of 20×20, and parallelly outputs the pre-processing coefficient values (9-bit) corresponding to the pre-processed image scanned by the window size of 20×20. The parallelly-outputted pre-processing coefficient values are inputted into the cost calculation unit 240 that includes a 20×20 look-up table, which is pre-learned (or pre-trained).

The cost calculation unit 240 uses each pre-processing coefficient value (9-bit) of the pre-processed image of 20×20 (400 pixels) parallelly received from the window extraction unit 230 as an address to read out all the cost values corresponding to 400 pixels stored in the look-up table. Then, all the read-out cost values corresponding to 400 pixels are summed. The total sum of the cost values is provided to the face pattern discrimination unit 250 as a final cost value (hereinafter, referred to as a block cost value) of the block of 20×20 window size.

The face pattern discrimination unit 250 receives the block cost value, and compares the block cost value with a preset threshold value. If the block cost value is less than the threshold value, the block of 20×20 window size is discriminated as a face pattern. The face pattern discrimination unit 250 detects all coordinate values existing in the block discriminated as the face pattern, and stores the detected coordinate values in the coordinate storage unit 260. The coordinate values stored in the coordinate storage unit 260 are inputted into the image overlay unit 280.

The image overlay unit 280 outputs an image by performing an overlay function of representing only the face pattern on an original input image stored in the image storage unit 210 using the coordinate values.

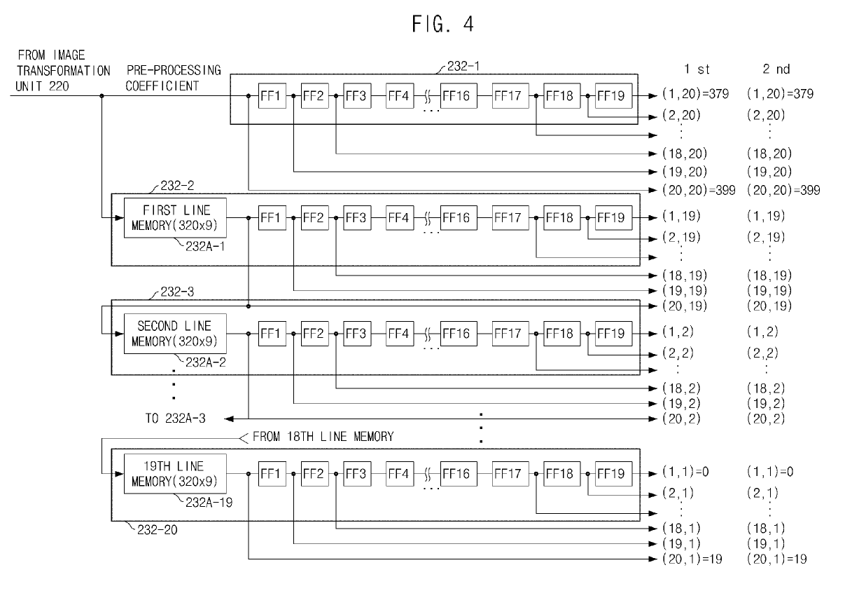

FIG. 4 is a circuit diagram illustrating an exemplary internal configuration of the window extraction unit of FIG. 3.

Referring to FIG. 4, the window extraction unit 230 sequentially receives MCT coefficient values (9-bit) corresponding to the 20×20 pre-processed image from the image transformation unit 220, and stores the MCT coefficient values. The window extraction unit 230 outputs the stored MCT coefficient values parallelly.

For this, the window extraction unit 230 includes a plurality of memories storing the MCT coefficient values (9-bit) corresponding to the pre-processed image in horizontal lines.

More specifically, the window extraction unit 230 includes first to 20th memories 232-1, 232-2 and 232-3, - - -, 232-20 to store MCT coefficient values (9 bit) by horizontal line, respectively.

The first memory 232-1 includes nineteen flip-flops FF1, . . . , FF19 having a 9-bit width that are connected in series. The second memory 232-2 includes a first line memory 232A-1 and nineteen flip-flops FF1, . . . , FF19 having a 9-bit width that are connected in series. The third memory 232-3 includes a second line memory 232A-2 and nineteen flip-flops FF1, . . . , FF19 having a 9-bit width that are connected in series. The 20-th memory 232-20 includes a 19th line memory 232A-19 and nineteen flip-flops FF1, . . . , FF19 having a 9-bit width that are connected in series. Thus, other memories 232-2 and 232-3, . . . , 232-20 except the first memory 232-1 have the same structure. An input terminal of the first line memory 232A-1 in the second memory 232-2 is connected in an input terminal of the first memory 232-1. An input terminal of the second line memory 232A-2 in the third memory 232-3 is connected in an output terminal of the first line memory 232A-1. The third line memory (not shown) is connected to the second line memory 232A-2. In a similar connection manner, an input terminal of the 19th line memory 232A-19 is connected to an output terminal of the 18th line memory 232A-18.

Coefficient values corresponding to one horizontal line are stored in each line memory. Accordingly, each line memory stores data of 320×9 bits.

More specifically, coefficient values corresponding to the first horizontal line of a pre-processed image of 20×20 size are stored in the 19th line memory 232A-19, through the first to the 18th line memories 232A-1, . . . , 232A-18. The coefficient values corresponding to the first horizontal line stored in the 19th line memory 232A-19 are parallelly outputted through 19 flip-flops FF1, . . . , FF19 that are serially-connected to the 19th line memory 232A-19 and have a width of 9-bits. That is, the coefficient value of the first pixel (1, 1) of the first horizontal line stored in the 19th line memory 232A-19 is finally outputted from the output terminal of the 19th flip-flop FF19 through 19 flip-flops FF1, . . . , FF19. The coefficient value of second pixel (2, 1) of the first horizontal line is finally outputted from the output terminal of the 18th flip-flop FF18 through 18 flip-flops FF1, . . . , FF18. The coefficient value of 19th pixel (19, 1) of the first horizontal line is finally outputted from the output terminal of the first flip-flop FF1 through the first flip-flops FF1. The coefficient value of 20th pixel (20, 1) of first time horizontal line is outputted through the input terminal of first flip-flop FF1. Thus, the 20th memory 232-20 sequentially stores the coefficient values of the pixels (1, 1), (2, 1), . . . , (20, 1) of the first horizontal line of the 20×20 pre-processed image, and parallelly outputs the stored coefficient values of the first horizontal line.

In the same way, the 19th memory (not shown) sequentially stores the coefficient values of the pixels (1, 19), (2, 19), . . . ,(20, 19) of the 19th horizontal line of the 20×20 pre-processed image, and parallelly outputs the stored coefficient values of the 19th horizontal line.

In the second memory 232-1, the coefficient values of the pixels (1, 20), (2, 20), . . . ,(20, 20) of the 20th horizontal line of the 20×20 pre-processed image is not stored in the line memory, but inputted into 19 flip-flops FF1, FF2, . . . , FF19 connected in series to be outputted parallelly.

Thus, the window extraction unit 230 uses 19 line memories and 380 flip-flops to parallelly and simultaneously output coefficient values pertaining to 400 points that corresponds to the first scanned 20×20 window. Then, coefficient values pertaining to 400 points that corresponds to the second-scanned 20×20 window is parallelly and simultaneously outputted at a next clock.

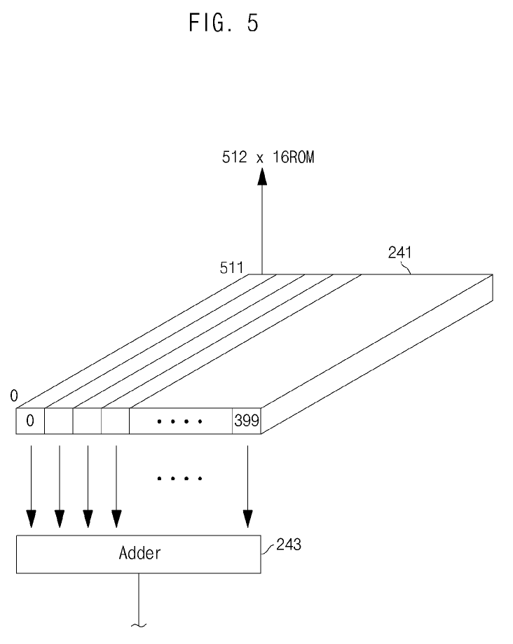

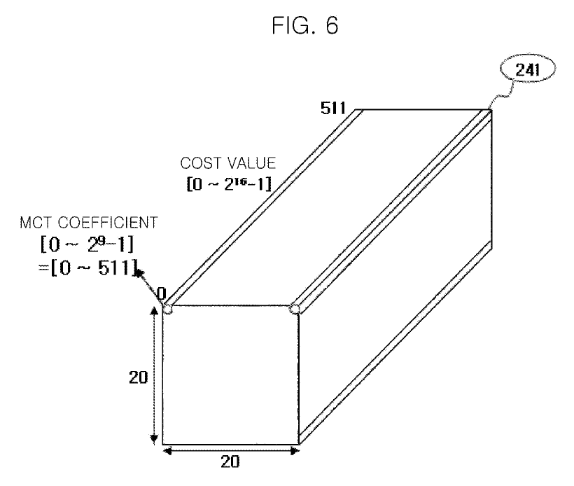

FIG. 5 is a diagram illustrating an exemplary internal configuration of a cost calculation unit in FIG. 3, and FIG. 6 is a diagram illustrating a look-up table in FIG. 5.

Referring to FIGS. 5 and 6, 400 cost values of 16-bits corresponding to a pixel are stored in a look-up table 241 of 20×20 size. The address of each pixel includes 9-bits. The memory size per pixel of the look-up table is 512×16 bits. Because pixels of 20×20 are arranged, a total of 400 512×16 memories is included.

A pixel (1, 1) is 0 point, and a pixel (1, 20) is 20 points. A pixel (20, 20) is 399 points. As an example, a look-up table for each point is implemented in a ROM of 512×16 bits. Accordingly, there are 400 ROMs.

The MCT coefficient values of 400 points outputted from the window extraction unit 230 in FIG. 3 are addressed in the look-up table 241 for corresponding points. 400 cost values read out from the look-up table 241 are summed by an adder 243. The sum becomes a final cost value of a corresponding window of 20×20, i.e., a block cost value.

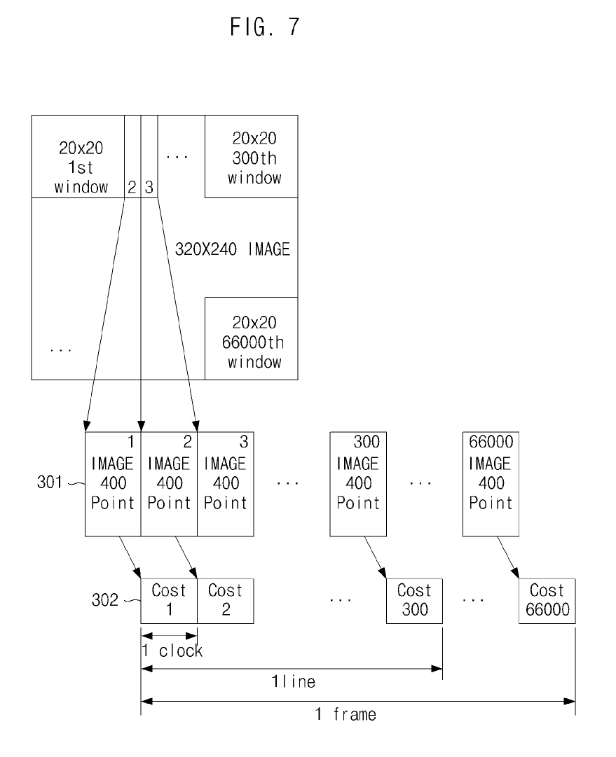

FIG. 7 is a diagram illustrating an exemplary internal process of a cost calculation unit in FIG. 3.

Referring to FIG. 7, coefficient values of 400 points with respect to a 20×20 image among input images are parallelly and sequentially outputted from the window extraction unit 230. That is, 400 point values with respect to the first window and the second window are processed at one clock interval, respectively.

Thus, by addressing the image coefficient value of 400 points in the look-up table memory having a parallel structure in the cost calculation unit 240, 400 cost values are simultaneously read out. Accordingly, a calculation process of one cost value with respect to a 20×20 window can be completed with one clock.

Subsequently, the exemplary embodiments enable high-speed and real-time face pattern detection through a parallel hardware configuration.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for detecting a face pattern from an input image, comprising:
a window extraction unit receiving a pre-processed image corresponding to the input image to scan the preprocessed image in a certain window size, and parallelly outputting pre-processing coefficient values corresponding to the scanned pre-processed image;
a cost calculation unit parallelly receiving the pre-processing coefficient values corresponding to the window size, calculating cost values corresponding to the pre-processed coefficient values, and summing the cost values; and
a face pattern discrimination unit comparing the summed cost values with a preset threshold value and discriminating if the pre-processed image corresponding to the window size is the face pattern.

2. The system of claim 1, further comprising:
an image storage unit sequentially receiving and storing the input image comprising a unit pixel of n (where n is a natural number) bits by frame unit;
an image transformation unit sequentially receiving the input image outputted from the image storage unit and transforming the input image into the pre-processed image comprising a unit pixel of m (where m is a natural number greater than n) bits; and
an image scaling unit sequentially receiving the input image outputted from the image storage unit, scaling down the input image at a certain scale-down ratio, and storing the scaled-down input image in the image storage unit.

3. The system of claim 1, wherein the window extraction unit sequentially receives and stores the pre-processing coefficient values corresponding to the pre-processed image of the window size by horizontal line unit, and parallelly outputs the stored pre-processing coefficient values.

4. The system of claim 1, wherein the window extraction unit comprises first to k-th (where k is a natural number greater than 3) memories parallelly outputting the coefficient values by horizontal line unit,
the first to k−1-th memories comprises:
a line memory storing coefficient values corresponding to horizontal lines of first to k−1-th horizontal lines; and
a plurality of flip-flops connected in series, and parallelly outputting the coefficient values corresponding to the horizontal lines sequentially outputted from the line memory, and
the k-th memory comprises a plurality of flip-flops connected in series, and sequentially and parallelly outputting coefficient values of k-th horizontal line.

5. The system of claim 4, wherein an i-th (1<i<k) line memory delivers coefficient values corresponding to a horizontal line to an i+1-th line memory.

6. The system of claim 5, wherein an input terminal of the i-th line memory is connected to an output terminal of an i−1-th line memory, and the output terminal of the i-th line memory is connected to an input terminal of the i+1-th line memory.

7. The system of claim 1, wherein the cost calculation unit comprises a memory with a look-up table comprising the cost values corresponding to the pre-processing coefficient values.

8. A method for detecting a face pattern from an input image, comprising:
parallelly calculating pre-processing coefficient values corresponding to a pre-processed image by receiving a pre-processed image corresponding to the input image and scanning the pre-processed image in a certain window size;
summing cost values by parallelly receiving the calculated pre-processing coefficient values and calculating the cost values corresponding to the pre-processed coefficient values; and
discriminating if the input image corresponding to the window size is the face pattern, by comparing the sum of the cost values with a preset threshold value.

9. The method of claim 8, further comprising transforming the input image comprising a unit pixel of n (where n is a natural number) bits into the pre-processed image comprising a unit pixel of m (where m is a natural number greater than n) bits.

10. The method of claim 8, wherein the parallel calculating of pre-processing coefficient values comprises:
sequentially receiving the pre-processing coefficient values corresponding to the pre-processed image of the window size to store the pre-processing coefficient values; and
parallelly outputting the stored pre-processing coefficient values.

11. The method of claim 8, further comprising storing the cost value in a form of a look-up table, wherein the summing of cost values comprises reading out the cost values by using the pre-processing coefficient values as addresses and accessing the look-up table.

12. A system for detecting a face pattern from an input image, comprising:
an image transformation unit transforming the input image comprising a unit pixel of n (where n is a natural number) bits into a pre-processed image of m (where m is a natural number greater than n) bits;
a window extraction unit comprising a memory scanning the pre-processed image in a certain window size, storing coefficient values of the pre-processed image corresponding to the window size by horizontal line unit, and parallelly and simultaneously outputting the coefficient values stored by horizontal line unit;
a cost calculation unit parallelly receiving the pre-processing coefficient values corresponding to the window size, calculating cost values corresponding to the pre-processed coefficient values, and summing the cost values; and
a face pattern discrimination unit comparing the summed cost values with a preset threshold value and discriminating if the pre-processed image corresponding to the window size is the face pattern.

13. The system of claim 12, wherein the memory comprises first to k-th (where k is a natural number greater than 3) memories parallelly outputting the coefficient values by horizontal line unit,
the first to k−1-th memories comprises:
a line memory storing coefficient values corresponding to a horizontal line of first to k−1-th horizontal lines; and
a plurality of flip-flops connected in series, and parallelly outputting the coefficient values corresponding to the horizontal line sequentially outputted from the line memory, and
the k-th memory comprises a plurality of flip-flops connected in series, and sequentially and parallelly outputting coefficient values of a k-th horizontal line.

14. The system of claim 12, where the face pattern discrimination unit outputs all coordinate values in the pre-processed image as a resulting value if the pre-processed image corresponding to the window size is discriminated as the face pattern.

15. The system of claim 14, further comprising:
a coordinate storage unit receiving and storing the coordinate values outputted from the face pattern discrimination unit; and
an image overlay unit representing a face region on an original input image stored in the image storage unit using the coordinate values stored in the coordinate storage unit.
